(19) United States
(12) Patent Application Publication
(10) Pub. No.: US 2004/0133922 A1
(43) Pub. Date: Jul. 8, 2004

(54) Receiving apparatus, printer and printing control method for digital image information

(76) Inventors: Hiroo Okamoto, Yokohama (JP); Hitoaki Owashi, Yokohama (JP); Satoshi Sano, Yokohama (JP); Hiroyuki Koreeda, Fujisawa (JP); Kenji Katsumata, Yokohama (JP)

Correspondence Address: MCDERMOTT, WILL & EMERY, 600 13th Street, N.W., Washington, DC, 20005-3096, US

(21) Appl. No.: 10/722,076

(22) Filed: Nov. 26, 2003

(30) Foreign Application Priority Data
Nov. 27, 2002 (JP) 2002-343180

(51) Int. Cl. H04N 7/16; H04N 7/173

(52) U.S. Cl. 725/133; 725/141; 725/153

(57) ABSTRACT

In an apparatus and a method for enabling control on print permission, without applying new control information or a protection method, copy control information is detected, which is added to digital information, when controlling the printing of digital information, thereby controlling on whether the printing can be conducted on the digital information depending upon the copy control information detected.

### BACKGROUND OF THE INVENTION

It is possible to improve usability for a user if enabling the user to print out digital image information, such as, static image data transmitted through a digital broadcastings, and static images extracted from television services, etc., thereby for storing and checking thereof. However, since some of them are not allowed to be printed out by an author or an owner of the copyright of the images, or are limited by the number of printings, therefore it is necessary to control the printings thereof.

As a method for controlling the printing of digital image information transmitted through the digital broadcastings, etc., it is conceived to provide a printing permission flag, newly, in such as European Patent EP 1 085 740 A2 (2001), in particular, on pages 3 to 5 and in FIG. 1 thereof, for example.

For the purpose of copy control in a recording apparatus, etc., copy control information, such as, CGMS, etc., has been used, however according to the conventional art mentioned above, there is newly provided the printing permission flag for conducting the printing control upon the printings, which are not considered in the copy control information, thereby performing the control on printings.

### SUMMARY OF THE INVENTION

The present invention relates to a receiving apparatus and a printer for printing and controlling digital image information, and it relates to, in particular, an apparatus and a method for enabling managements of the copyrights, etc. appropriately.

Though it is possible to conduct the control on the printings with certainty, with those matters disclosed in the conventional art mentioned above, however it is necessary to transmit new information. Also, for the purpose of protection of the copyright, etc., it is necessary to protect the information from being stolen or pulled out illegally, even when transmitting the digital image information to be printed out to a printer. However, with the conventional art mentioned above, nothing is taken into the consideration, in particular, about protection of the information when it is transmitted.

According to the present invention, by taking such the problem mentioned above into the consideration thereof, it is an object to provide an apparatus and a method, enabling the control upon printing permission, without using such new control information or protection method, and being able to protect the information.

For achieving such the object mentioned above, according to the present invention, there is provided a receiving apparatus, for receiving digital information, thereby outputting it into a printer, comprising: a receiving circuit for receiving said digital information; an extractor circuit for extracting static image information from said digital information; a recording/reproducing circuit for recording therein the static image information extracted; and an output circuit for outputting the static image information reproduced from said recording/reproducing circuit, with adding copy control information thereto, as information being able to control printing of said printer. Also, according to the present invention, there is provided a printer for printing digital information inputted, comprising: an input circuit for inputting said digital information; a printer circuit for printing said digital information inputted; and a control circuit for detecting copy control information added to said digital information, thereby to perform printing in said printer circuit depending upon the copy control information detected. And, further, according to the present invention, there is provided a printing control method, for controlling printing of digital information, comprising the following steps of: detecting copy control information, which is added to said digital information; and controlling on whether conducting or not the printing of said digital information depending upon said copy control information detected.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram of a system as a whole, in which a receiving apparatus and a printing method are applied, according to the present invention;

FIG. 2 is a block diagram for showing an example of the structure of an information providing station 1 shown in FIG. 1 mentioned above;

FIG. 3 is a block diagram for showing an example of the structure of a receiving apparatus 3 shown in FIG. 1 mentioned above;

FIG. 4 is a block diagram for showing an example of the structure of a printer 7 shown in FIG. 1 mentioned above;

FIG. 5 is a block diagram of a system as a whole, in which a receiving apparatus and a printing method are applied, as a second embodiment according to the present invention;

FIG. 6 is a block diagram for showing an example of the structure of a receiving apparatus 8 shown in FIG. 5 mentioned above;

FIG. 7 is a flowchart for showing flow of printing processes in the printing apparatus, according to the present invention;

FIG. 8 is a block diagram for showing an example of the structure of a printer 7, in a third embodiment according to the present invention;

FIG. 9 is a flowchart for showing flow of printing processes, in the third embodiment according to the present invention;

FIG. 10 is a flowchart for showing flow of selecting processes of printing data, according to the present invention;

FIG. 11 shows an example of a screen for selecting a print frame, according to the present invention;

FIG. 12 shows an example of a screen for selecting data for use of printing thereof, according to the present invention;

FIG. 13 shows an example of a message of failure of printing, which is displayed on the receiving apparatus, according to the present invention; and

FIG. 14 is a flowchart for sowing flow when failing the printing, according to the present invention.

### DETAILED DESCRIPTION OF PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modification, which fall within the ambit of the appended claims.

Hereinafter, embodiments according to the present invention will be fully explained by referring to the attached drawings. First, explanation will be given on a system, into which the present invention is applied.

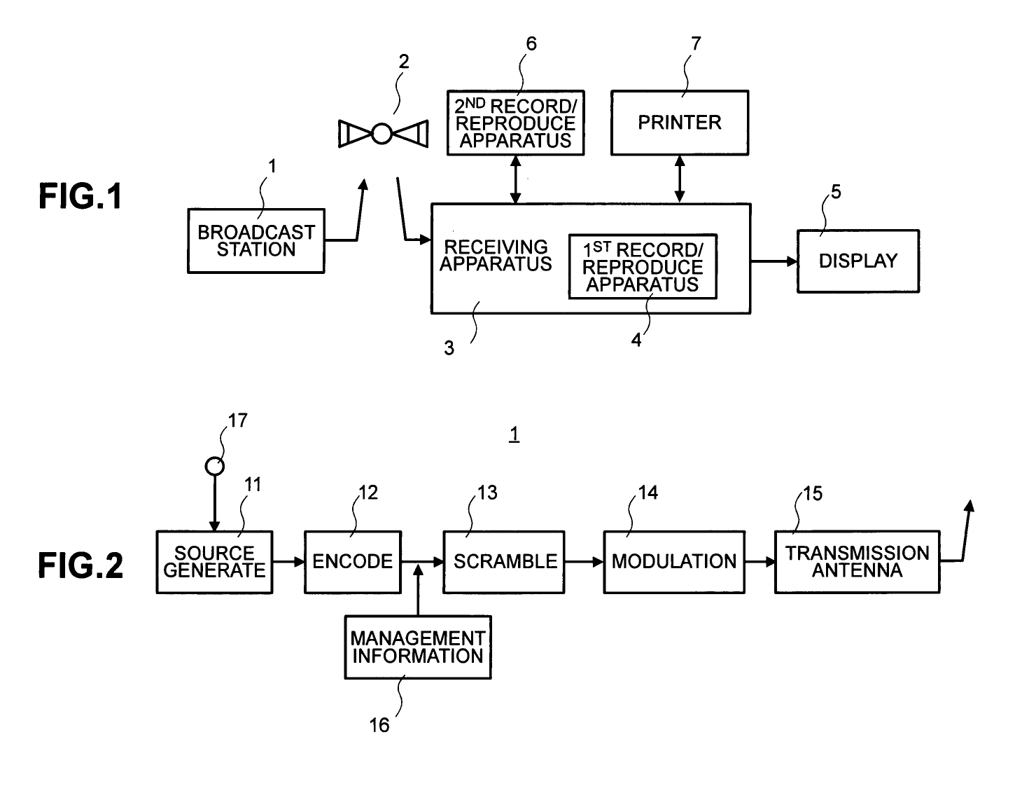

FIG. 1 is a block diagram for showing a first embodiment of the system as a whole, into which a receiving apparatus and a printer are used, according to the present invention. Information, being broadcasted from an information providing station 1, such as a broadcasting station, etc., through a relay station 2, is received at a receiving apparatus 3, and it is recorded/reproduced in a first recording/reproducing apparatus 4 and a second recording/reproducing apparatus 6, and further it is also printed out by a printing apparatus. And, also, it is viewed on a display 5.

The information providing station 1, such as the broadcasting station, etc., transmits information through a relay station 2, such as a broadcast satellite or the like, in the form of signal waves modulated upon the basis of the information. Other than this, it may be done through transmissions by means of a cable, a telephone line, and/or ground waves, etc., for example. After receiving and modulating the signal, the receiving apparatus 3 of a receiving side records the content of information received into the first recording/reproducing apparatus 4 and/or the second recording/reproducing apparatus 6, depending upon the necessity thereof. Also, the contents of information received is viewed directly on the display 5, or the information reproduced by the first and/or the second recording/reproducing apparatus 4 and/or 6 is viewed. When it is desired to print out the information received or the information recorded in the recording/reproducing apparatus, it is printed out through the printer 7.

It is assumed that the first recording/reproducing apparatus 4 is of a digital recording method, which is built in the receiving apparatus 3. As such a recording medium thereof, it is possible to apply a hard disk, for example. Also, such a memory medium or the like may be applied thereto. The second recording/reproducing apparatus 6 is attached in an outside of the receiving apparatus 3. Other than the hard disk, the recording medium may be a medium, which can be detached or removed therefrom, such as, a magnetic tape, an optical disk, etc.

Onto the information broadcasted is attached copy control information for controlling recording on the recording/reproducing apparatus. If the copy control information attached onto the information broadcasted is “Copy Free”, the information can be recorded in the first recording/reproducing apparatus 4 or the second recording/reproducing apparatus 6, without restriction, however if it is “Copy Never” or “Copy One Generation”, the recording of the information is limited, as will be mentioned later. Further, upon printing operation in the printer 7, if the copy control information is “Copy Free”, it is possible to decide that no protection is asserted thereon, such as the copyright, etc., thereby printing it without restriction, but if it is “Copy Never” or “Copy One Generation”, the printing thereof is restricted in the similar manner to the recording.

In an example shown in FIG. 1, it comprises two (2) sets of the recording/reproducing apparatuses and one (1) set of printer, however it should not be restricted only thereto. Namely, the present invention can be applied, irrespective of a number of sets of the apparatuses and of being built-in type or attached in an outside thereof. Also, the present invention should not be restricted only to the application into a system for recording/reproducing the information received or printing it. The present invention can be applied, of course, not only a case of reproducing package software recorded in advance, but also in a case of only receiving the information being on the air at present, thereby displaying it on the display 5, or also in a case where the information is recorded or printed in a PC (Personal Computer), etc.

FIG. 2 is a block diagram for showing an example of the structure of the information providing station 1 shown in FIG. 1 mentioned above. The information, such as, video/audio or the like, which is generated in a source generating portion 11 comprising therein a camera, a recording/reproducing apparatus, etc., is compressed in an amount of data thereof, so as to be transmitted through a less occupying band width, by means of an encode circuit 12 through MPEG method, etc., for example. In a case when the protection, such as, the copy protection, etc., is necessary, it is encrypted or scrambled in a scramble circuit 13 for transmission thereof. After being modulated by a modulation circuit 14 into a signal being suitable for transmission, the information is emitted in the form of radio waves from a transmission antenna 15 to the relay station 2, such as, the broadcast satellite, etc. In this instance, such the copy control information mentioned above and so on are attached thereto, in a management information attributing circuit 16. Also, to an input terminal 17 is inputted request information from the receiver side upon “video on demand” through the telephone line, etc., and responding thereto is determined the information to be sent out.

Further, in many cases, a plural number of information is multiplexed onto the radio wave signals to be transmitted, through the method, such as, time-sharing, spectrum dispersion, etc. In this instance, systems are provided in a plural number, each including the source generating portions 11 and the encode circuit 12, and a multiplex circuit is provided between the encode circuit 12 and the scramble circuit 13, for multiplexing a plural number of information.

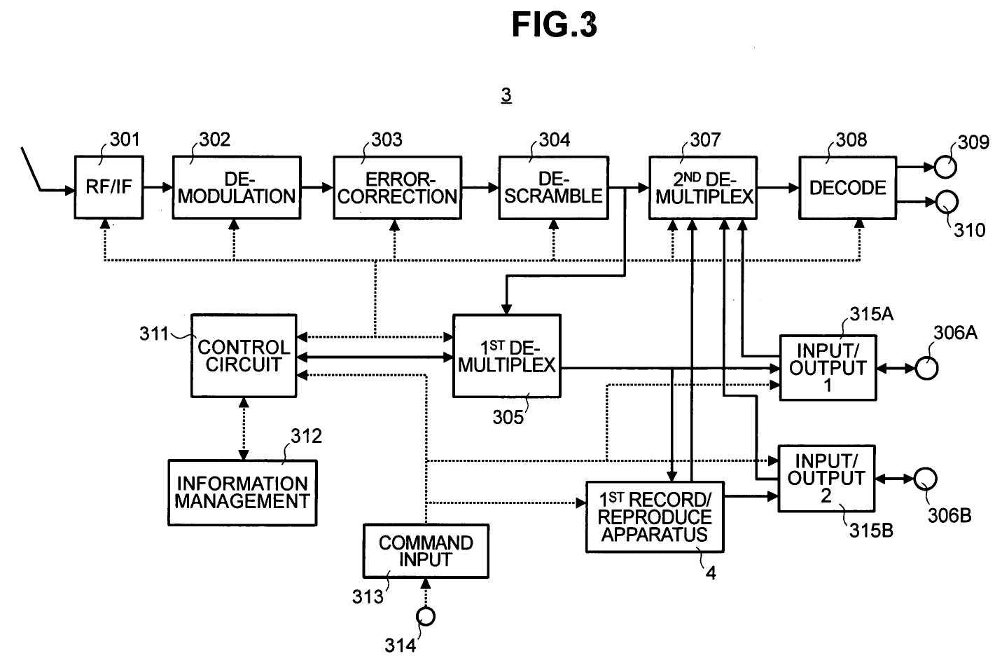

FIG. 3 is a block diagram for showing an example of the structure of the receiving apparatus 3 in the system shown in FIG. 1 mentioned above. Solid lines in the figure indicate flows if main information, such as, the video/audio received, and broken lines flows indicate the control signal information between each of the constituent elements thereof.

First of all, explanation will be given along with the flows of the main information, such as, the video/audio or the like, which are indicated by the solid lines. Radio wave is inputted into a RF/IF conversion circuit 301, which is emitted from the relay station, for example, the broadcast satellite, etc. Here, the radio waves of the RF band are converted on the frequency thereof into an IF (Intermediate Frequency) band, and also are constant in the bandwidth irrespective of or independent from the receiving channels thereof. They are de-modulated from the modulation operation that was conducted in the de-modulation circuit 302 for transmission. Further, after detecting errors in codes generated on the way of transmission in an error correction circuit 303, to be corrected, removal of the encryption or scrambling for transmission is done in the de-scramble circuit 304. Thereafter, it is transmitted to the first and the second de-multiplex circuits 305 and 307. The de-multiplex circuits 305 and 307 divide or separate only desired information from the plural number of information, which are multiplexed on one (1) channel. The reason of provision of the two (2) sets of de-multiplex circuits lies in, not only for enabling to record a program on a different channel, but also for the purpose of deleting the information not to be recorded and adding the information to be recorded in the first de-multiplex circuit 305. For example, those programs, such as, weather forecast, broadcasting schedule of programs, etc., for example, which are not necessary to be recorded, are removed here.

An output of the first de-multiplex circuit 305 is given, not only to the first recording/reproducing apparatus 4, but also to an input/output circuit 315A. To the input/output circuit 315A is also connected the second recording/reproducing apparatus 6, through an input/output terminal 306A. Also, an output reproduced form the first recording/reproducing apparatus 4 is given to an input/output circuit 315B. To the input/output circuit 315B is also connected the printer 7 through an input/output terminal 306B.

The input/output circuits 315A and 315B are bi-directional input/output interfaces, for example, and they receives and sends information to be recorded/reproduced or printed, and/or commands for controlling apparatuses, etc., between the second recording/reproducing apparatus 6 and the printer 7, in the form of digital data. In general, the connection according to the standard of IEEE1394 is used, in may cases. Also, it may be the USB (Universal Series Bus) or the wireless LAN (Local Area Network), which is widely used in the PC. Also, in a case where information can be transmitted on plural kinds thereof, as is in the IEEE1394, it is possible to replace the input/output circuits 315A and 315B with a same input/output circuit and input/output terminal, in common. Further, it is possible to provide the input/output circuits in a plural number thereof, or also possible to use a plural number of input/output interfaces, which are different in the specification thereof.

In the first and second recording/reproducing apparatuses 4 and 6, a recording operation is performed in accordance with the copy control information. If the copy control information is indicative of “Copy never”, no recording is performed thereof. If it is of “Copy One Generation”, it is recorded after re-writing that into “No More Copies”. If it is of “No More Copies”, no recording is performed thereof. If it is of “Copy Free”, it is recorded as it is. Other than those, in a case where reproduction is only allowed to the apparatus that perform the recording; such as, in a case where the recording medium is of a hard disk, etc., being un-detachable, it is permitted to “Copy Temporarily” with provision of a limitation on a term for use of the reproduction thereof, irrespective of the condition of “Never Copy”, such as, up to 90 minutes, for example, to “Move” the information with provision of bringing the original information recorded into un-reproducible irrespective of the condition of “No More Copies”, and to reproduce an output while keeping the condition of “Copy One Generation” within a time limit when recording the information of “Copy One Generation”, for example, 90 minutes.

For conducting such the control on copying as was mentioned above in the outside recording/reproducing apparatus, such as, the second recording/reproducing apparatus 6, for example, the input/output circuit provides an output with adding such the copy control information as was mentioned above onto the information to be recorded. Further, for preventing it from illegal steal or pulling out thereof, the information is encrypted or scrambled to be outputted depending upon the necessity thereof.

To the second de-multiplex circuit 307 is inputted the information sent from the de-scramble circuit 304, the information reproduced in the first recording/reproducing apparatus 4, or the information reproduced in the second recording/reproducing apparatus 6A provided through the input/output circuit 315A, and desired information is selected and/or divided from them. In the next decode circuit 308; de-compressing process is treated on the data compression, which was treated before the transmission thereof through, such as, the MPEG method or the like, and the data is transmitted to an apparatus of an outside through output terminals 309 and 310. The output terminals 309 and 310 may be either one of digital outputs or analogue outputs, or may be used separately; such as, the former is of the digital output and the latter is of the analogue output, for example. The output terminal may be only one (1) in the number thereof.

Next, the structures will be described in FIG. 3, along with the control signals indicated by broken lines therein. The control circuit 311 performs the transmission of control signals among the respective constituent elements, starting from the RF/IF converter circuit 301 mentioned above and reaching to the first and second de-multiplex circuits 305 and 307, the decode circuit 308, and further the input/output circuits 315A and 315B, thereby controlling the receiving apparatus 3 to perform a desired operation thereof as a whole. The information management circuit 312 supplies the control circuit 311 with management data for conducting the control, depending upon a request thereof. For example, herein is managed the information of receiving contracts, etc. When a user designates a channel that she/he wishes to view, that designation is inputted from the input terminal 314 thereof, and is transmitted to the control circuit 311 through the command input circuit 313. The control circuit 311 requires the receiving contract information to the information management circuit 312. In case when deciding that there exist the channel and the contract that the user designates therein, the control signals are transmitted to the respective constituent elements mentioned above, thereby to conduct control operations, such as, designation of the receiving operation of the said channel, etc. Also, within the control circuit 311 are conducted the followings; such as, detection of the copy control information, control on the copy depending upon the copy control information detected, and/or production of the copy control information to be added to the information to be outputted.

Next, description will be made on the control of printing. As the information to be printed, they include the static image information that is transmitted for the purpose of printing, such as a data service, etc., and the static image information extracted for printing, from the image information that is transmitted for viewing thereof, such as, a television service, etc. In a case of the former, the static image information separated in the first de-multiplex circuit 305 is recorded into the first recording/reproducing apparatus 4. Also, in a case of the latter, a portion(s), being selected by the user from the image information under the condition of transmission or reproduction, for the purpose of printing thereof, is extracted in the form of the static image(s), and is/are recorded into the first recording/reproducing apparatus 4. The static image information recorded, after being read into the control circuit 311, once, and converted into data for use of printing therein, is outputted to the printer 7 from the second input/output circuit 315B, thereby to be printed out. However, it is also possible to output the static image information without conversion into the data for use in printing, but it is converted into the data for use in printing within the printer 7. Further, when transmitting the static image information for the purpose of printing, it is also possible to transmit the data it self for use in printing. In this instance, there is no necessity of conversion thereof into the data for use in printing.

Moreover, upon extraction of the static image information from the image information, while recoding the image information of a certain time period into the recording/reproducing apparatus 4, always, and if the user can select the portion to be extracted, from the image information recorded in the recording/reproducing apparatus 4, from a time when the user selects the printing up to a time prior thereto by the certain time period, it is possible to improve the usability much more.

The control of printing is also conducted, in accordance with the copy control information, as shown in TABLE 1 below.

TABLE 1

| Copy Control Information | | Copy | Scrambled | |
|---|---|---|---|---|
| CCI | EPN | Control | Transmission | Printing |
| 00 | 1 | Copy Free | No | Possible |
| 00 | 0 | Copy Free | Yes | Possible |
| 10 | 1 | Copy One | Yes | Possible |
| | | Generation | | |
| 01 | 1 | No More | Yes | Impossible |
| | | Copies | | |
| 11 | 1 | Copy Never | Yes | Impossible |

The CCI (Copy Control Information) is of two (2) bit information, and when it is “00”, it indicates “Copy Free”, when “10”, “Copy One Generation”, when “01”, “No More Copies”, and when “11”, “No More Copies”, respectively. However, no “No More Copies” is used for transmission, such as, in the broadcasting, etc. When the CCI is in any one of the conditions, but other than “00”, it is transmitted while being scrambled, thereby protecting the information thereof when it is copied illegally. The “EPN” is a one (1) bit information, and when this information is “0”, no restriction is made on copy thereof, however indicates that it is transmitted while being scrambled. With this, the information is protected from illegal use thereof, but other than the copy thereof by means of regular or proper recording equipment. Among of those, when it is “Copy Free” or “Copy One Generation” where the copy thereof is permitted, it is possible to make the copy thereof, while when “No More Copies” or “Copy Never” where the copy thereof is prohibited, it is impossible to make the copy thereof. With this, it is also possible to make the control, not only upon copying thereof but also printing, in the similar manner.

When the information is transmitted with addition of the copy control information, such as, “Copy Free”, since the static image information recorded in the recording/reproducing apparatus 4 is outputted under the condition of “Copy Free”, therefore it can be printed out without restriction thereupon. On the other hand, when it is transmitted with addition of the copy control information, such as, “Copy One Generation”, although the static image information recorded in the recording/reproducing apparatus 4 can be printed out, but within a limited time period, since it is outputted under the condition of “Copy One Generation”, however after elapsing the limited time period, it cannot be printed out any more, since it is outputted under the condition of “Copy Never”. Namely, the time period when it can be printed out is restricted. Further, although it is possible to make the copy thereof even after elapsing the limited time period, since it is outputted under the condition of “Copy One Generation” if being outputted through the “Move”, however since the original information comes to be irreproducible in the condition thereof, therefore the number of printing is limited only to one (1) time. In this manner, depending upon the copy control information, it is possible to perform the flowing controls; such as, printing without limitation, printing with limitation, and impossible of printing, for example, in the similar manner to the copy control.

A TABLE 2 below shows other embodiment of the copy control information.

TABLE 2

| Copy Control | | | | Scrambled | | |
|---|---|---|---|---|---|---|
| Information | | | | Trans- | | Print |
| CCI | EPN | ICT | Copy Control | mission | Print | Resolution |
| 00 | 1 | 1 | Copy Free | No | Possible | No |
| | | | | | | Limitation |
| 00 | 0 | 1 | Copy Free | Yes | Possible | No |
| | | | | | | Limitation |
| 00 | 0 | 0 | Copy Free | Yes | Possible | With |
| | | | | | | Limitation |
| 10 | 1 | 1 | Copy One | Yes | Possible | No |
| | | | Generation | | | Limitation |
| 10 | 1 | 0 | Copy One | Yes | Possible | With |
| | | | Generation | | | Limitation |
| 01 | 1 | 1 | No More Copy | Yes | Impossible | — |
| 11 | 1 | 1 | Copy Never | Yes | Impossible | — |

The ICT is information, which is provided for restricting resolution of an analogue image output, and when this information is “0”, it restricts the resolution. In printing, if restricting the printing resolution by means of this information, it is possible to restrict the resolution; i.e., to restrict the printing at high resolution, too.

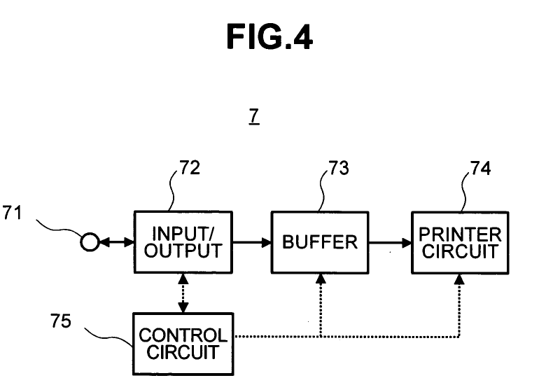

FIG. 4 is a block diagram for showing an example of the structure of the printer 7. Data for use in printing inputted from an input/output terminal 71 is written into a buffer 73 through an input/output circuit 72, and the data read out from the buffer 73 is transmitted to a printing circuit 74, thereby to be printed out. In the input/output circuit 72, the copy control information is extracted from the transmitted information, thereby to be transmitted to a control circuit 75. And, in the control circuit, control is done on whether the printing should be conducted or not depending upon the copy control information. Also, if there is restriction on the resolution, the restriction is conducted on the printing resolution. However, if it is transmitted while being scrambled, decryption is conducted in the input/output circuit 72.

According to this embodiment, with restriction on the resolution of the static image information, it is possible to protect the copyright thereof, substantially, even when permitting the printing.

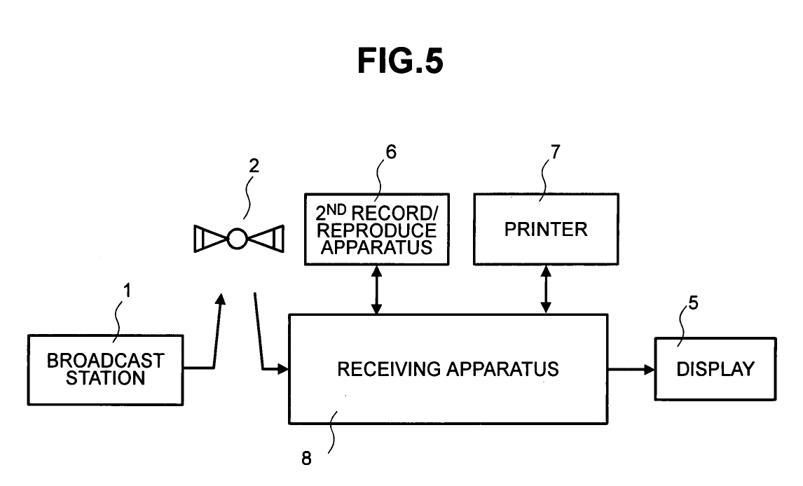

FIG. 5 is a block diagram for showing a second embodiment of the system, as a whole, to be applied into the receiving apparatus and the printer, according to the present invention. Comparing to the first embodiment mentioned above, this differs from it, in particular, in that the receiving apparatus 8 does not includes the first recording/reproducing apparatus 4 therein. Other than that receiving apparatus 8, they are same to those shown in FIG. 1; therefore explanation is omitted herein, being made thereof.

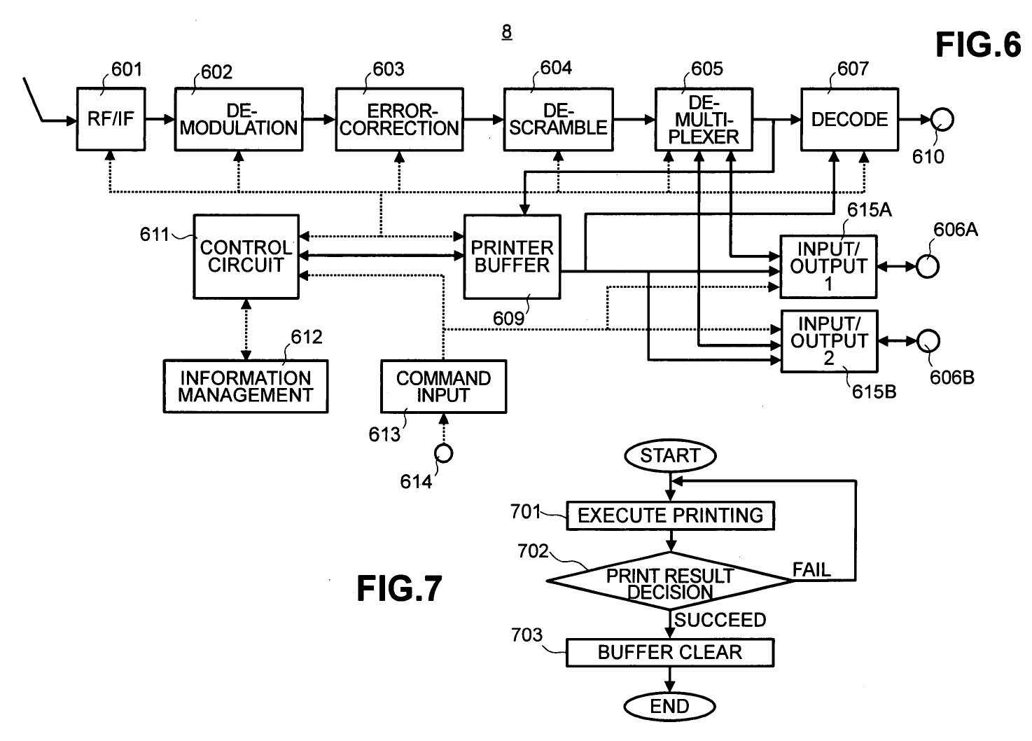

FIG. 6 is a block diagram for showing the structure of the receiving apparatus 8 in the second embodiment according to the present invention. Solid lines in the figure indicate flows of the main information, such as, the image and the audio, etc., while broken lines in the figure flows of the control signals. First, the structure of the present embodiment will be explained along with the flow of the main information, such as the image/audio indicted by the solid lines.

Into a RF/IF converter circuit 601 is inputted radio waves from the relay station, such as the satellite for use of broadcasting, etc., for example. Herein, the radio wave of RF (Radio Frequency) bandwidth is converted in the frequency into IF (Intermediate Frequency) bandwidth, and it turns to be a signal of a certain bandwidth independent from the receiving channels, thereby being demodulated from the modulation operation conducted for the transmission thereof in a demodulation circuit 602. Further, after detecting and also correcting the errors generating on the way of the transmission, in an error correction circuit 603, the de-scramble is conducted on the scramble for transmission in the de-scramble circuit 604. Thereafter, it is transmitted to the de-multiplex circuit 605. The de-multiplex circuit 605 separates only a desired information from a plural number of information multiplexed on one (1) channel.

An output of the de-multiplex circuit 605 is provided, not only to the printer buffer, but also to an input/output circuit 615A. To the input/output circuit 615A is connected a second recording/reproducing apparatus 6 through an input/output terminal 606A. Also, an output from the printer buffer is provided to an input/output circuit 615B. To the input/output circuit 615B is connected the printer 7 through an input/output terminal 606B.

Those input/output circuits 615A and 615B are bi-directional input/output interfaces, for example, and they transmit digital data, such as information to be recorded/reproduced or printed and/or commands for controlling apparatuses between the second recording/reproducing apparatus 6 and the printer 7. In general, the connection according to the IEEE1394 standard is widely used. Also, it may be USB (Universal Serial Bus) connection, which is widely used in the PC, or they may be connected with using the wireless LAN (Local Area Network) or the wired LAN, in the place thereof. Also, in a case where plural kinds of information can be transmitted, as is according to the IEEE1394 standard, the input/output circuits 815A and 815B may be used in common by the same input/output circuit and the input/output terminal. Further, the input/output circuits may be provided in a large number thereof, or a plural number of the input/output interfaces may be used, which are different in the specification thereof.

In the second recording/reproducing apparatus 6, the recording operation is conducted on the static image information, in accordance with the copy control information. If the copy control information is indicative of “Copy Never”, no recording is conducted thereon. If it is “Copy One Generation”, it is recorded after rewriting it into “No More Copy”. If it is indicative of “No More Copy”, no recording is conducted thereon. If it is “Copy Free”, it is recorded as it is. Other than those, in a case where reproduction is only allowed to the apparatus that perform the recording; such as, in a case where the recording medium is a hard disk, etc., being un-detachable, it is permitted to “Copy Temporarily” with provision of a limitation on a term for use of the reproduction thereof, irrespective of the condition of “Never Copy”, such as, up to 90 minutes, for example, to “Move” the information with provision of bringing the original information recorded into un-reproducible irrespective of the condition of “No More Copies”, and to reproduce an output while keeping the condition of “Copy One Generation” within a time limit when recording the information of “Copy One Generation”, for example, 90 minutes.

For the purpose of conducting such the control as mentioned above in recording/reproducing equipment in an outside, such as, the second recording/reproducing apparatus 6, for example, the input/output circuit outputs information to be recorded, adding such the copy control information as was mentioned above thereto. Further, for the purpose of protecting it from illegal stealing or pulling-out, the information is scrambled, depending upon the necessity thereof, to be outputted.

Next, explanation will be given on the flows of control indicated by the broken lines therein. A control circuit 611 transmits control signals among the RF/IF converter circuit 601, the demodulation circuit 602, the error correction circuit 603, the de-scramble circuit 604, the de-multiplex circuit 605, the decode circuit 607 and the printer buffer 609. It also transmits the control signals between the input/output circuit 1 and the input/output circuit 2. By means of the control signals mentioned above, the control is conducted on the receiving apparatus, so that it carries out the desired operation therein. An information management 612 manages the information necessary for the control circuit to control the respective constituent elements, and transmits it between the control circuit 611. The contents thereof are, such as, contract information of channels and programs, or the like, for example.

Next, explanation will be given on the control of printing. With the data to be printed out, it is transmitted in the form of the data for use in printing in advance, in one case, or in other case, the user selects a scene at her/his desire among the image information transmitted. In the former case, the data for use in printing is extracted by means of the de-multiplex circuit 605 and is stored into the printer buffer 609, together with the copy control information thereof. The control circuit 611 selects or picked up the data at desire of the user among the data stored within the printer buffer 609, according to an input from the command input 613, and outputs it to the printer 7. In the latter case, the image information, starting from the present time up to that prior to it by a certain time period, is always stored in the printer buffer 609 together with the copy control information thereof, and the scene of her/his desire is selected from those images, in accordance with the user's operation. The control circuit 611 produces the data for use in printing from the selected scene(s) and outputs it/them to the printer 7.

The control of the printing is conducted in accordance with the TABLE 1 or TABLE 2, or TABLE 3. Since the explanation about the TABLE 1 or TABLE 2 is same to that mentioned in the above, therefore it will be omitted herein. The TABLE 3 below is a third embodiment of the copy control information.

TABLE 3

| Copy Control Information | | Copy | Scrambled | |
|---|---|---|---|---|
| CCI | EPN | Control | Transmission | Printing |
| 00 | 1 | Copy Free | No | Possible |
| 00 | 0 | Copy Free | Yes | Possible |
| 10 | 1 | Copy One | Yes | Possible |
| | | Generation | | |
| 01 | 1 | No More | Yes | Possible |
| | | Copies | | |
| 11 | 1 | Copy Never | Yes | Impossible |

The Copy Control Information is of two (2) bit information, and when it is “00”, it indicates “Copy Free”, when “10”, “Copy One Generation”, when “01”, “No More Copies”, and when “11”, “No More Copies”, respectively. However, no “No More Copies” is used for transmission, such as, in the broadcasting, etc. When the CCI is in any one of the conditions, but other than “00”, it is transmitted while being scrambled, thereby protecting the information thereof when it is copied illegally. The “EPN” is a one (1) bit information, and when this information is “10”, no restriction is made on copy thereof, however indicates that it is transmitted while being scrambled. With this, the information is protected from illegal use thereof, but other than the copy thereof by means of regular or proper recording equipment.

With the data transmitted with addition of the copy control information, e.g., “No More Copies”, or the data inputted from an outside recording apparatus, it is also possible to extract the data to be printed out from it, by “moving” it to the printer. Inherently, an omission is generated in the original image after the “move”, however since there is a rule that the image data can exist at both an origin of moving and a destination of moving, at the same time, but within one (1) minutes, therefore the image can be remained as it is.

With the data transmitted while being attached with the copy control information, such as, “Never Copy”, “Copy One Generation”, or “Copy Free”, or the data inputted from the outside recording/reproducing apparatus, they are treated in the similar manner as in the TABLE 1, the explanation about them will be omitted herein.

Also, not deciding the permission of printing through decision of the copy control information in a control circuit 805 of the printer 4, but in a case where the copy control information attached to the print data is decided to be impermissible for printing in the control circuit 611 of the receiving apparatus 8, the data for use in printing is inhibited to be outputted to the printer 4, thereby it is also possible to make control on the printing by taking the copyrights into the consideration.

According to this embodiment, it is possible to conduct the printing control of the digital information by means of the copy control information, thereby protecting the copyrights thereof.

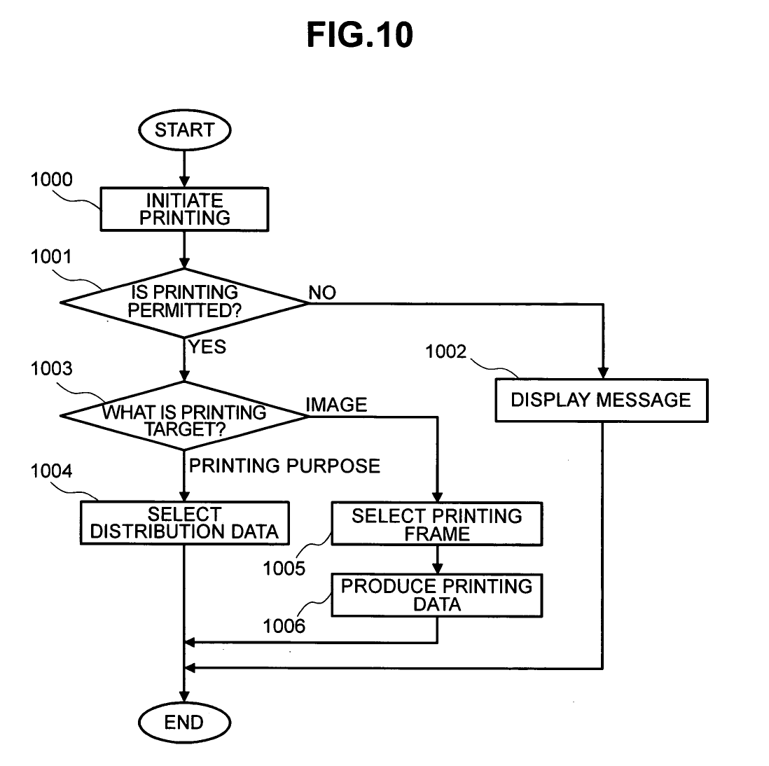

Next, explanation will be given on print data selecting processes, according to the present invention, by referring to the drawings. FIG. 10 is a flowchart for showing a flow of printing processes. First, in a step 1000, the receiving apparatus 8 starts a print data selection screen, in accordance with print starting operation made by the user. The operation of the print starting can be achieved by displaying menu items through OSD (On Screen Display), for example, and selecting the item, “Print” among of them, or it may be achieved by pushing down a print button, which is included on a main body of the receiving apparatus 8 or on a remote controller for operating the receiving apparatus 8.

In a step 1001, upon the basis of the copy control information extracted in the control circuit 611 of the receiving apparatus 8, it is discriminated on whether the printing can be done or not. In a case where the printing can be done, the process proceeds to a step 1003, on the other hand, in a case where the printing is not allowed, proceeding to a step 1002.

In the step 1002, a message is displayed on a display 5, by means of the control circuit 611, meaning that the printing is restricted, and the printing process is ended herein.

In the step 1003, upon basis of the user's operation to the command input 613, it is selected by the user, whether the data to be printed is distributed for the purpose of printing or is selection of the frame from the image data at her/his desire. This is decided, for example, by displaying a message to make selection of which print should be done in the form of the OSD, noticing the user's operation responding to this display from the command input 807 to the control circuit 618, thereby processing it in the control circuit 618. Herein, in a case where it is the data distributed for the purpose of printing, the step proceeds to a step 1005.

In a step 1004, if the data distributed for the purpose of printing are stored in a plural number thereof in the printer buffer 609, according to the user's operation to the command input 613, the data is selected at the desire. The selection of date can be achieved, for example, by displaying a data list screen 1201 for use of print, as shown in FIG. 12, thereby letting the user to move a selector cursor 1202 by means of the remote controller, so that she/he can make an operation of meaning a determination at the time when the selector cursor 1202 overlaps the data at the desire. Furthermore, by aligning the data displayed along with the items, such as, the date and time when the data is distributed, and also the channel, through which the data is distributed, etc., it is possible to make the selection of the data easy at her/his desire.

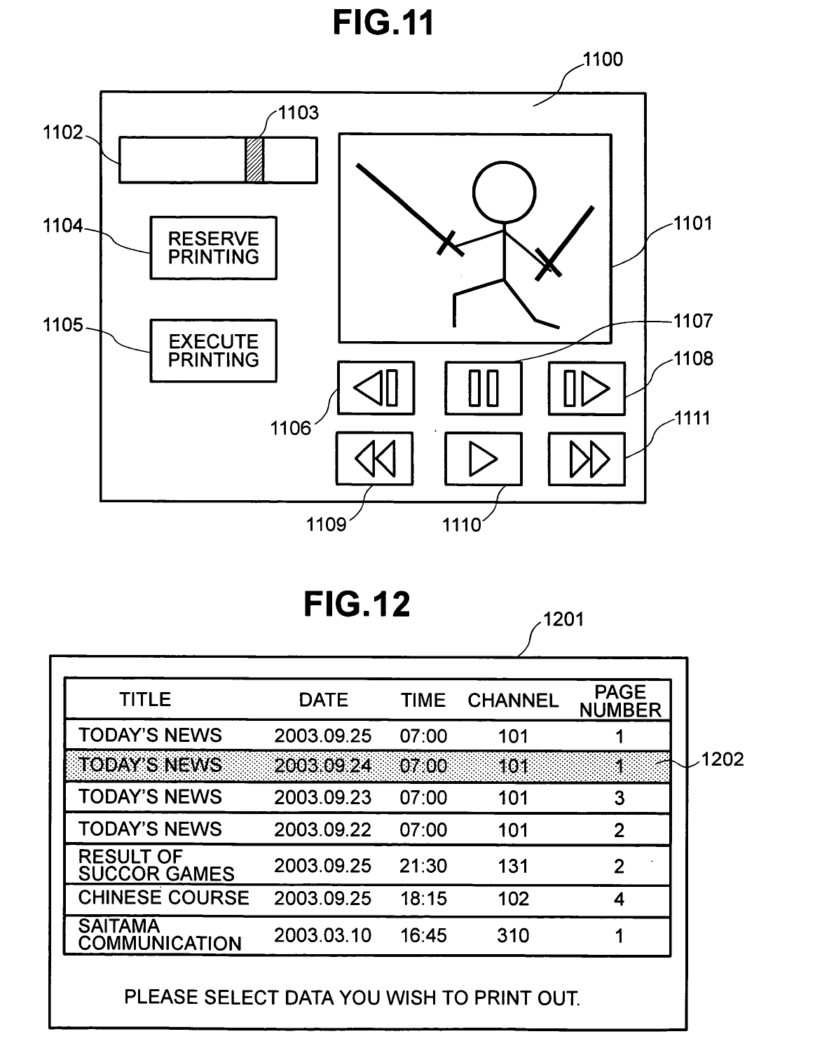

In the step 1005, from the images stored in the printer buffer 609 for the certain time period, a frame to be printed is selected upon basis of the user's operation to the command input 613. In this selection, a print frame selector screen 1100, for example, shown in FIG. 11 is displayed on the display. On an image display 1101 is displayed the reproduced image data, which is stored in the printer buffer 609. The user can select the frame(s) to be printed, by carrying out a print reservation 1104 or a print execution 1105 at the time when the frame at desire is displayed thereon. When the print execution 1105 is carried out, the frame displayed at present is added into the frame selector buffer, and the step proceeds to the step 1004, and when the print reservation 1104 is carried out, the frame selected is added into the frame selector buffer, thereby continuing the print frame selecting process. When the print execution is selected after conducting the print reservations in a plural number thereof, the frames selected up to that time are printed out, collectively.

Also, as the operations for the frame selection, the user can conduct the followings: reversal reproduction by a unit of frame of the images 1101, through a frame reverse button 1106; temporary stoppage of the image, through a temporary stop button 1107; advance of the image 1101 by a unit of frame, through a frame forward button; reproduction of the image 1101 through a reproduction button 1110; high-speed reversal reproduction of image though a quick reverse button 1109; and high-speed reproduction of the image 1101 through a quick forward button 1111. Further, she/he can make selection on the image at the desired time, by operating a present position indicator bar 1103 on a time bar 1102, indicating therein a total time of the images stored in the printer buffer and also the position where the image 1101 displays at present.

In a step 1006, the data for use in printing is produced upon basis of the information, which are selected in the step 1005 and stored into the frame selector buffer, in the control circuit 611. Further, after producing the data for use in printing, the data stored in the frame selector buffer are deleted therefrom. With the processes mentioned in the above, it is possible to select the data for use in printing at desire of the user.

Explanation will be made on a second embodiment of the printer, according to the present invention, by referring to the drawings attached. In the input/output circuit 72, the copy control information is extracted from the information transmitted, and it is sent to the control circuit 75. Then, in the control circuit, control is made on whether the printing should be done or not depending upon the copy control information. Also, when there is the restriction on resolution, the printing resolution is restricted. Further, when it is transmitted with scrambling thereon, de-scrambling is conducted on the scrambling in the input/output circuit 72. When deciding that the printing should be done in the control circuit 72, the printing processes are conducted, in accordance with the flowchart shown in FIG. 7.

In a step 701, the printer circuit 74 reads out the print data from the buffer 73, in accordance with an instruction from the control circuit 75, thereby executing the printing. It also informs the control circuit of whether the printing is completed normally or not. In a step 702, upon basis of the printing result informed from the printer circuit, i.e., if the printing is completed normally, the step proceeds to a step 703. If the printing is not completed normally, it turns back to the step 701, and executes the printing, again. In the step 703, the control circuit 75 deletes the print data within the buffer, and completing the printing.

According to the present embodiment, by conducting deletion on the buffer of the printer after completion of the printing, the data can be protected from leaking into an outside from the printer, thereby taking the copyright of the print data into the consideration.

However, the deletion of the print data should not always done in the step 703, but in such the case, it is necessary to take such measure into the consideration, that the data for use in printing cannot be stolen or pulled out illegally, in particular when other digital equipment is connected to the printer.

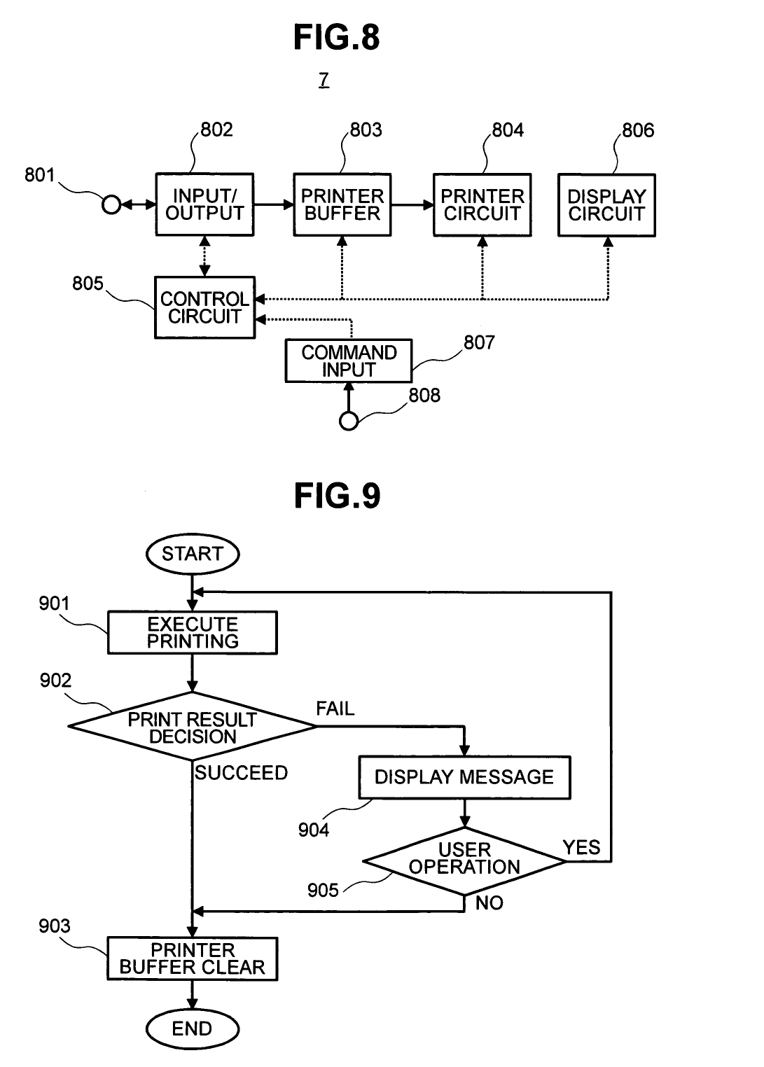

Explanation will be made on a third embodiment of the printer, according to the present invention, by referring to FIGS. 8 and 9. Herein, FIG. 8 is a view for showing the structure of the printer, according to the present embodiment. In an input/output circuit 802, the copy control information is extracted from the information transmitted, and it is sent to a control circuit 805. Then, in the control circuit 805, control is made on whether printing should be done or not in accordance with the copy control information. Also, when there is the restriction on resolution, the printing resolution is restricted. Further, when it is transmitted with scrambling thereon, de-scrambling is conducted on the scrambling in the input/output circuit 802. When deciding that the printing should be done in the control circuit 805, the printing processes are conducted, in accordance with the flowchart shown in FIG. 9.

The data for use in printing, which is inputted from an input/output terminal 801, is written into a buffer 803 through the input/output circuit 802, and the data read out from the butter 803 is transmitted to a printer circuit 804, thereby to be printed out. Also, the printer circuit 804 informs the control circuit 805 of whether the printing is completed normally or not. In a display circuit 806, display is done to the user, in accordance with an instruction from the control circuit 805, receiving the information on whether the printing is conducted normally or not in the printer circuit 804. This display can be achieved through a message display with using a liquid crystal display or light emission of LED (Light Emitting Diode), for example. A command input 807 informs the control circuit 805 of the user's input to a command input terminal 808, such as a button provided in the printer 7, etc.

FIG. 9 is a flowchart for showing a flow of print control, according to the present embodiment. In a step 901, the printer circuit 804 reads out data from the printer buffer 803 in accordance with an instruction from the control circuit 805, and executes the printing. It also informs the control circuit 805 of whether the printing is completed normally or not. Ina step 902, the control circuit 805 determines on whether the printing is completed normally or not, upon basis of the information from the printer circuit 804. In a case when the printing is completed normally, the process proceeds to a step 903, on the other hand, when the printing is not completed normally, it proceeds to a step 904. In the step 903, the control circuit 805 deletes the data for use in printing stored within the printer buffer 803, thereby completing the printing processes. In the step 904, it sends an instruction to the display circuit 806, so as to conduct a display indicative of the failure printing, but without deleting the data for use in printing within the printer buffer 803. Upon receipt of this, the display circuit 806 conducts the display indicative of the failure of printing. In a step 905, the display indicative of the failure of printing is conducted, and in a case, when the user inputs a request for re-execution of printing to the user input terminal 808, the printing of the print data within the printer buffer 803 is re-executed. In a case where no operation is made by the user to give an intention for re-printing, the printing is ended, but deleting the print data stored in the printer buffer 803. However, the deletion of the print data should not always done, but in such the case, it is necessary to take such measure into the consideration, that the data for use in printing cannot be stolen or pulled out illegally, in particular when other digital equipment is connected to the printer. With such the processes as was mentioned above, it is possible to achieve the print control by taking the copyright protection into the consideration.

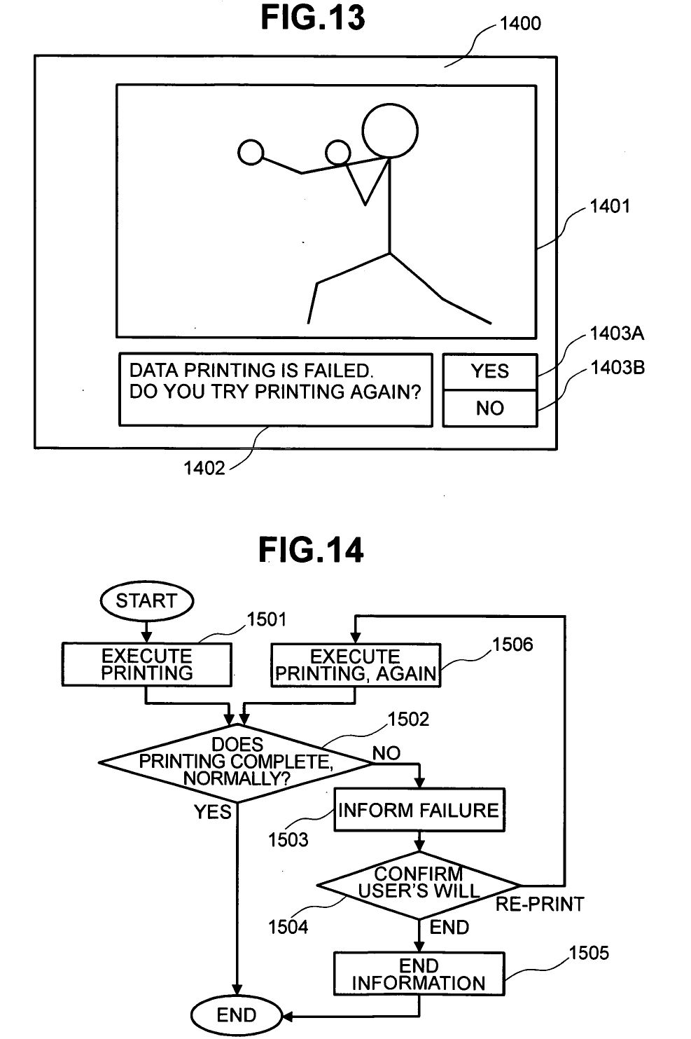

In the processes conducted in the receiving apparatus and the printer, according to the present invention, in particular, when failing the printing, explanation will be given on an embodiment of informing the user that an abnormality occurs in the printing by using the receiving apparatus, with referring to the drawings attached. FIG. 14 is a flowchart for showing a flow of processes when failing the printing, according to the present invention. In a step 1501, first the data for use in printing is sent out from the input/output of the receiving apparatus to the printer. Next, after storing the data for use in printing into the buffer 73 through the input/output 72, the printer 7 executes the printing through the printer circuit 74.

In a step 1502, upon receipt of the information of the print result from the printer circuit 74, the control circuit decides on if the printing is completed normally, or if an abnormality occurs in the printing. Herein, in the case when the printing is completed normally, the process is completed as it is. In a case when the abnormality occurs, it proceeds to a step 1503.

In the step 1503, the information of failing the printing is made from the control circuit 75 of the printer 7, through the input/output terminal 70 and the input/output terminal 606, to the control circuit 611 of the receiving apparatus 8. The control circuit 611 can make information of failure of printing to the user, by displaying such a print failure message 1402, as is in a print failure information screen 1400, shown in FIG. 13, for example. Also, it is possible to display the print failure message thereon, without disturbing the view of the image, by adjusting the sizes of the image 1401 under the condition of viewing thereof. Further, it is possible to confirm the necessity of re-printing, by letting the user to select one while displaying two choices 1403A and 1403B, inquiring of the necessity of the re-printing.

In a step 1504, the process is divided upon selection made in the step 1503, i.e., whether the re-printing is necessary or not. In a case where the re-printing is decided not necessary, it proceeds to a step 1505, on the other hand, it proceeds to a step 1506 when the re-printing is required.

In the step 1505, information is given from the receiving apparatus 8 to the printer 4, that the printing is completed. Upon receipt of that information, the printer 7 deletes the information within the buffer thereof. However, the deletion of the print data should not always done, but in such the case, it is necessary to take such measure into the consideration, that the data for use in printing cannot be stolen or pulled out illegally, in particular when other digital equipment is connected to the printer.

In the step 1506, information of requesting re-execution of the printing is transmitted from the receiving apparatus 8 to the printer 4. Upon receipt of that information, the printer 7 executes the re-printing of the information stored within the printer buffer.

With such the processes as were mentioned in the above, it is possible to inform the user of the failure of printing through the receiving apparatus, and also to select the necessity of re-execution of the printing depending on the selection made by the user.

As was mentioned in the above, according to the present invention, it is possible to achieve the control on permission of printing and the protection from being stolen or pulled out illegally, without using a control information or a method for excusive use thereof, with ease.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A receiving apparatus, for receiving digital information, thereby outputting it into a printer, comprising:
a receiving circuit for receiving said digital information;
an extractor circuit for extracting static image information from said digital information;
a recording/reproducing circuit for recording therein the static image information extracted; and
an output circuit for outputting the static image information reproduced from said recording/reproducing circuit, with adding copy control information thereto, as information being able to control printing of said printer.

2. The receiving apparatus, as described in the claim 1, further comprising:
a converter circuit for converting said static image information into data for use in printing, wherein
said output circuit adds the copy control information to said data for use in printing, so as to output it.

3. The receiving apparatus, as described in the claim 1, wherein said output circuit scrambles said static image information depending upon the copy control information, so as to output it.

4. The receiving apparatus, as described in the claim 1, wherein said digital information is digital image information.

5. A printer for printing digital information inputted, comprising:
an input circuit for inputting said digital information;
a printer circuit for printing said digital information inputted; and
a control circuit for detecting copy control information added to said digital information, thereby to perform printing in said printer circuit depending upon the copy control information detected.

6. The printer, as described in the claim 5, wherein said control circuit makes control so that the printing is conducted when said copy control information permits a copy thereof, while the printing is not conducted when it does not permits the copy thereof.

7. The printer, as described in the claim 5, wherein the digital information is scrambled, and said input circuit performs de-scrambling on the information inputted with scrambling thereon.

8. A printing control method, for controlling printing of digital information, comprising the following steps of:
detecting copy control information, which is added to said digital information; and
controlling on whether conducting or not the printing of said digital information depending upon said copy control information detected.

9. The printing control method, as described in the claim 8, wherein the printing is conducted when said copy control information permits a copy, while it is not conducted when not permitting the copy.

10. The printing control method, as described in the claim 8, wherein no data for use in printing is outputted when said copy control information does not permit the printing.

11. The printing control method, as described in the claim 8, wherein it is informed to a user that said digital information cannot be printed out, when said copy control information does not permit the printing.

12. The printing control method, as described in the claim 8, wherein transmission of print data in the printing of said digital data is conducted by “move” thereof.

13. The printing control method, as described in the claim 8, wherein the printing is performed when said copy control information is either one of “Copy Free”, “Copy One Generation” and “No More Copy”, allowing the “move”, on the other hand the printing is not performed when it is “Copy Never” not allowing the “move”.

14. The printing control method, as described in the claim 8, comprising a contemporary buffer for use of printing, a print screen selecting means, and means for initiating said print screen selecting means, wherein a print screen is selected from the digital information stored in said temporary buffer for use of printing by means of said print screen selecting means.

15. The printer, as described in the claim 5, wherein said control circuit deletes the digital information stored within the printer, when the printing is completed without generating an abnormality during the printing.

16. The printer, as described in the claim 5, wherein said control circuit prints out the digital information stored within the printer, again, when an abnormality generates during the printing.

17. The printer, as described in the claim 5, further comprising a display circuit for indicating on whether the printing is completed normally or not, wherein said display circuit displays that the printing is failed when the printing is failed.

18. The printer, as described in the claim 17, wherein said control circuit makes setting on whether the printing should be done or not, again, depending upon a user input conducted to the input circuit, which is made responding to display by means of the display circuit.

19. The printer, as described in the claim 5, wherein said control circuit informs that the printing is failed, to a digital apparatus, which outputs the print data, when the printing is failed.

20. The receiving apparatus, as claimed in the claim 1, further comprising a display circuit for indicating a print failure message when receiving information of print failure from the printer.
